(19) United States
(12) Patent Application Publication
(10) Pub. No.: US 2008/0052026 A1
(43) Pub. Date: Feb. 28, 2008

(54) CONFIGURING A CONTENT CAPTURE DEVICE FOR ONE OR MORE SERVICE PROVIDERS

(75) Inventors: Christopher M. Amidon, Apex, NC (US); Alfredo C. Issa, Apex, NC (US); Richard J. Walsh, Raleigh, NC (US)

Correspondence Address: FlashPoint Technology and Withrow & Terranova, 100 Regency Forest Drive, Suite 160, Cary, NC, 27518, US

(73) Assignee: QURIO HOLDINGS, INC., Raleigh, NC (US)

(21) Appl. No.: 11/466,629

(22) Filed: Aug. 23, 2006

(51) Int. Cl. G06F 19/00

(52) U.S. Cl. 702/104; 709/220; 709/221; 713/1; 713/100; 702/85

(57) ABSTRACT

A system and method for automatically configuring a content capture device according to a configuration profile for a desired service are provided. In general, the user of the content capture device registers for one or more services. Thereafter, in one embodiment, the user of the content capture device selects one of a desired service prior to content capture. In another embodiment, the desired service is selected based on contextual information obtained by the content capture device. Once the desired service is selected, the content capture device obtains a configuration profile for the desired service. The configuration profile includes required or suggested configurations for the content capture device when capturing content to be distributed to the desired service. The content capture device performs an auto-configuration process based on the configuration profile. Once the content capture device is configured, content captured by the content capture device is distributed to the desired service.

### FIELD OF THE INVENTION

The present invention relates to digital content capture devices and more specifically relates to a system and method for configuring a digital content capture device based on required or suggested configurations for a desired service provider.

### BACKGROUND OF THE INVENTION

Digital content capture devices such as digital cameras and digital video cameras have become prolific in our society. As a result, numerous online sharing and printing services have emerged. Typically, these services impose or suggest various requirements for the digital content. For example, due to storage space limitations, online sharing services may limit a file size of each shared image or video to a set maximum file size. In contrast, printing services may require or recommend high quality images cropped for a desired photo print size. Other online services, such as e-Bay®, may impose various limitations or restrictions on the file size and dimensions of posted images of a user's merchandise. As a result of the varying requirements of these types of online services, owners of digital content are forced to spend valuable time cropping, resizing, and otherwise editing captured content before providing the content to desired services. Thus, there is a need for a system and method of automatically configuring a content capture device according to recommended or suggested configurations for a desired service and distributing captured content to the desired service.

### SUMMARY OF THE INVENTION

The present invention provides a system and method for automatically configuring a content capture device according to a configuration profile for a desired service. In general, the user of the content capture device registers for one or more services. Thereafter, in one embodiment, the user of the content capture device selects a desired service prior to content capture. Once the desired service is selected, the content capture device obtains a configuration profile for the desired service. The configuration profile includes required or suggested configurations for the content capture device when capturing content to be distributed to the desired service. The content capture device performs an auto-configuration process based on the configuration profile. Once the content capture device is configured, content captured by the content capture device is distributed to the desired service.

In another embodiment, the content capture device automatically selects or recommends services based on contextual information. Once the desired service is selected, the content capture device obtains a configuration profile for the desired service and performs an auto-configuration process based on the configuration profile. Once the content capture device is configured, content captured by the content capture device is distributed to the desired service.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system for configuring a content capture device for one or more desired services according to one embodiment of the present invention;

FIG. 2 illustrates the operation of the system wherein the user selects one or more desired services and the content capture device is configured for the desired services according to one embodiment of the present invention;

FIG. 3 illustrates the operation of the system wherein the user selects one or more desired services and the content capture device is configured for the desired services according to another embodiment of the present invention;

FIGS. 4A and 4B illustrate the operation of the system wherein the content capture device automatically selects or recommends one or more desired services based on contextual information obtained by the content capture device and the content capture device is configured for the desired services according to one embodiment of the present invention;

FIGS. 5A and 5B illustrate the operation of the system wherein the content capture device automatically selects or recommends one or more desired services based on contextual information obtained by the content capture device and the content capture device is configured for the desired services according to another embodiment of the present invention;

FIG. 6 is a block diagram of an exemplary embodiment of the content capture device of FIG. 1 according to one embodiment of the present invention; and

FIG. 7 is a block diagram of an exemplary embodiment of the Digital Configuration Hub (DCH) server of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

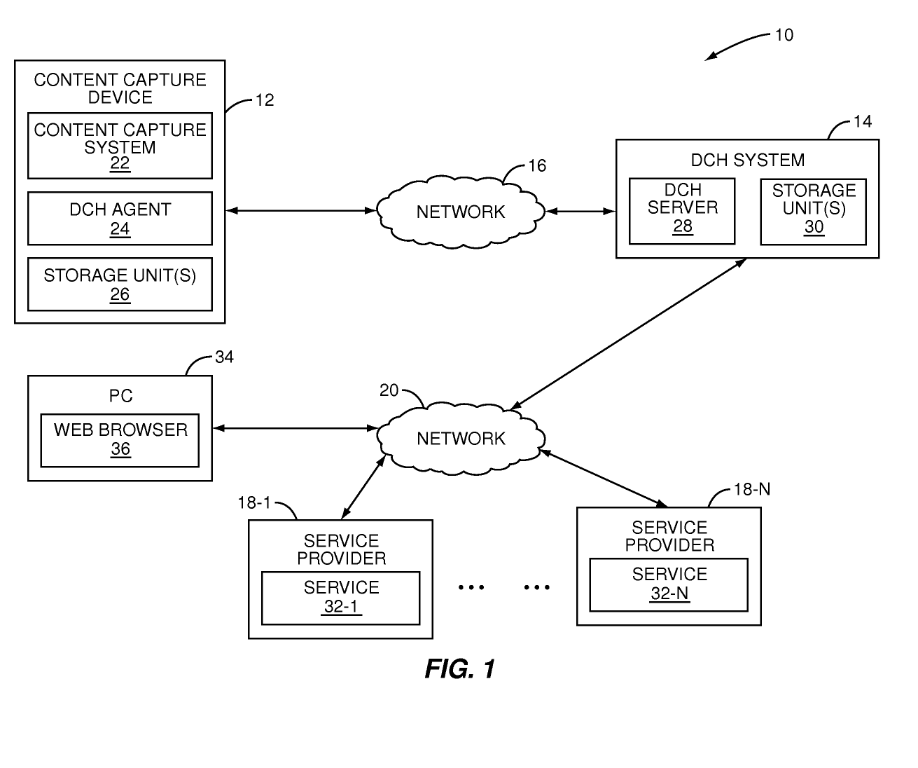

FIG. 1 illustrates a system 10 incorporating the present invention. In general, the system 10 includes a content capture device 12 and a Digital Configuration Hub (DCH) system 14 interconnected by a network 16. While only one content capture device 12 is illustrated, any number of content capture devices 12 may be served by the DCH system 14. The network 16 may be a local area network (LAN); a wide area network (WAN) such as, for example, the Internet; a cellular network; or any combination thereof. The DCH system 14 is also connected to a number of service providers 18-1, 18-N via a network 20. The network 20 is preferably a distributed public WAN such as, for example, the Internet. Note that while the networks 16 and 20 are illustrated as separate networks, the networks 16 and 20 may be interconnected or alternatively be the same network.

The content capture device 12 may be any digital content capture device or any device having content capture capabilities. The content capture device 12 may capture digital content such as digital images, digital video and associated audio, and the like. For example, the content capture device 12 may be a digital image camera or video camera having either a local wireless interface or a cellular network interface for communicating with the network 16, a mobile telephone having content capture capabilities and a cellular network interface to the network 16, a Personal Digital Assistant (PDA) having content capture capabilities and either a local wireless interface or a cellular network interface to the network 16, or the like. Exemplary local wireless interfaces may be wireless interfaces operating according to standards such as, but not limited to, the Bluetooth standard, one of the suite of IEEE 802.11 standards, or the like. Exemplary cellular network interfaces may be network interfaces operating according to standards such as, but not limited to, the Global System for Mobile Communications (GSM) standard, the Wideband Code Division Multiple Access (WCDMA) standard, or the like.

The content capture device 12 generally includes a content capture system 22, a DCH agent 24, and one or more storage units 26. The content capture system 22 may include a combination of hardware and software enabling content capture. The DCH agent 24 may be implemented in hardware, software, or a combination of hardware and software and operates to communicate with the DCH system 14 for configuration of the content capture device 12 for desired services provided by the service providers 18-1, 18-N and distribution of captured content to the desired services. The storage unit 26 may be any digital storage unit such as, for example, internal Random Access Memory (RAM), a removable memory card, an internal or external hard-disc drive, an optical storage device such as a Compact Disc (CD) or Digital Video Disc (DVD) recorder, or the like. The storage unit 26 operates to store content captured by the content capture device 12.

The DCH system 14 includes a DCH server 28 and one or more storage units 30. The DCH server 28 may be implemented in software, hardware, or a combination of hardware or software. While a single DCH server 28 is illustrated, the DCH system 14 may include a number of DCH servers 28 which may be co-located or distributed. The DCH server 28 generally operates as a unified hub, or configuration and distribution node, between the content capture device 12 and all of the service providers 18-1, 18-N. The DCH system 14 also includes one or more storage units 30. The storage units 30 may be, for example, one or more local or networked hard-disc drives or the like.

The service providers 18-1, 18-N host associated services 32-1, 32-N. The service 32-1 is preferably hosted by one or more servers associated with the service provider 18-1. Likewise, the service 32-N is preferably hosted by one or more servers associated with the service provider 18-N. The services 32-1, 32-N may be, for example, photo sharing web services such as, for example, Qurio, MySpace, and Flickr; e-commerce web services such as, for example, e-Bay; or photo printing services such as, for example, the photo printing web service provided by WalMart. Notably, one of the services 32-1, 32-N may be a home content server associated with the user of the content capture device 12. The home content server may be a service hosted by, for example, a user device associated with the user of the content capture device 12 such as personal computer (PC) 34. The services 32-1, 32-N may additionally or alternatively include video sharing web services, services for generating DVDs using captured video, or the like.

The system 10 may also include the PC 34, or the like, associated with the user of the content capture device 12. As discussed below, the user associated with the PC 34 and the content capture device 12 may interact with the DCH server 28 via, for example, a web browser 36 on the PC 34 to register with the DCH server 28 and one or more of the service providers 18-1, 18-N. Alternatively, the user may register via the content capture device 12.

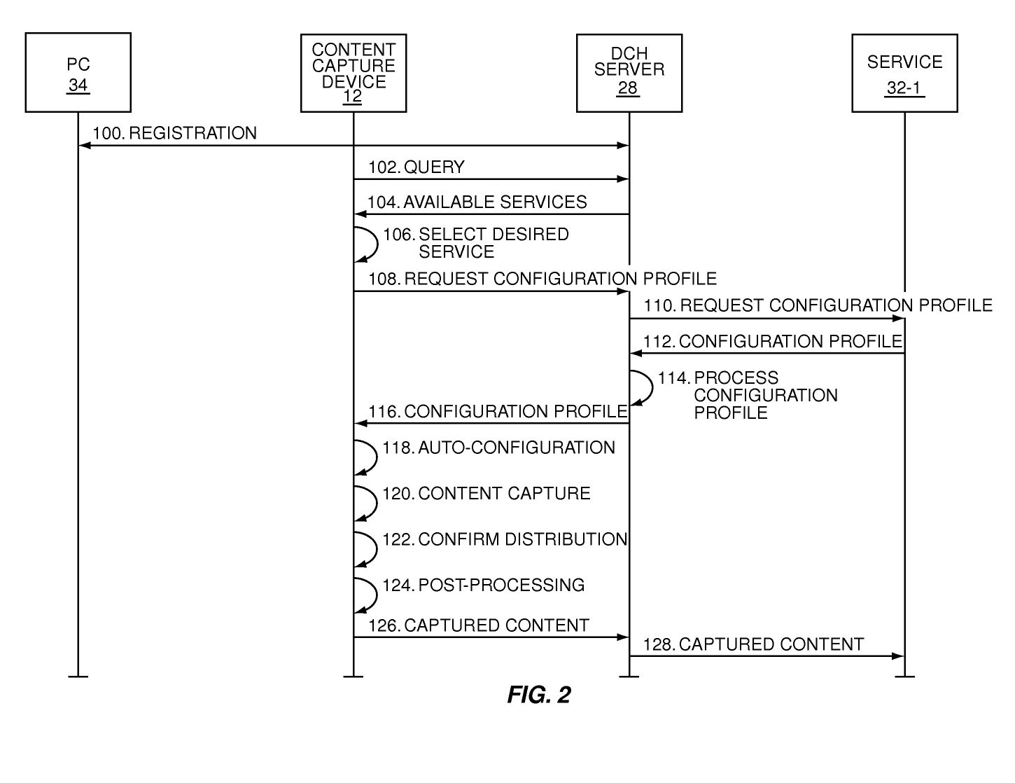

FIG. 2 illustrates the operation of the system 10 according to one embodiment of the present invention. The process begins when the user registers with the DCH server 28 and the services 32-1, 32-N (step 100). During registration with the DCH server 28, the user may provide information such as, for example, the user's name, address, phone number, e-mail address, and the like. In this embodiment, the user also interacts with the DCH server 28 to effect registration with the services 32-1, 32-N. The DCH server 28 may use the information provided by the user during registration to automatically provide at least a portion of the information required for registration with the services 32-1, 32-N. Any additional information required for registration may be provided by the user.

At some point thereafter, such as after start-up of the content capture device 12, the DCH agent 24 of the content capture device 12 queries the DCH server 28 for available services (step 102). In response, the DCH server 28 provides information identifying the services 32-1, 32-N with which the user has registered (step 104). The information identifying the services 32-1, 32-N may include, for example, names of the services 32-1, 32-N, Uniform Resource Locators (URLs) for the services 32-1, 32-N, information describing the services 32-1, 32-N, or the like. Alternatively, rather than registering for the services 32-1, 32-N beforehand, the DCH server 28 may recommend or suggest the services 32-1, 32-N in response to the query. The user of the content capture device 12 may then register with the services 32-1, 32-N via the content capture device 12. In this case, the DCH server 28 may automatically provide information already obtained during the user's registration with the DCH server 28 such that the user is only required to enter new information.

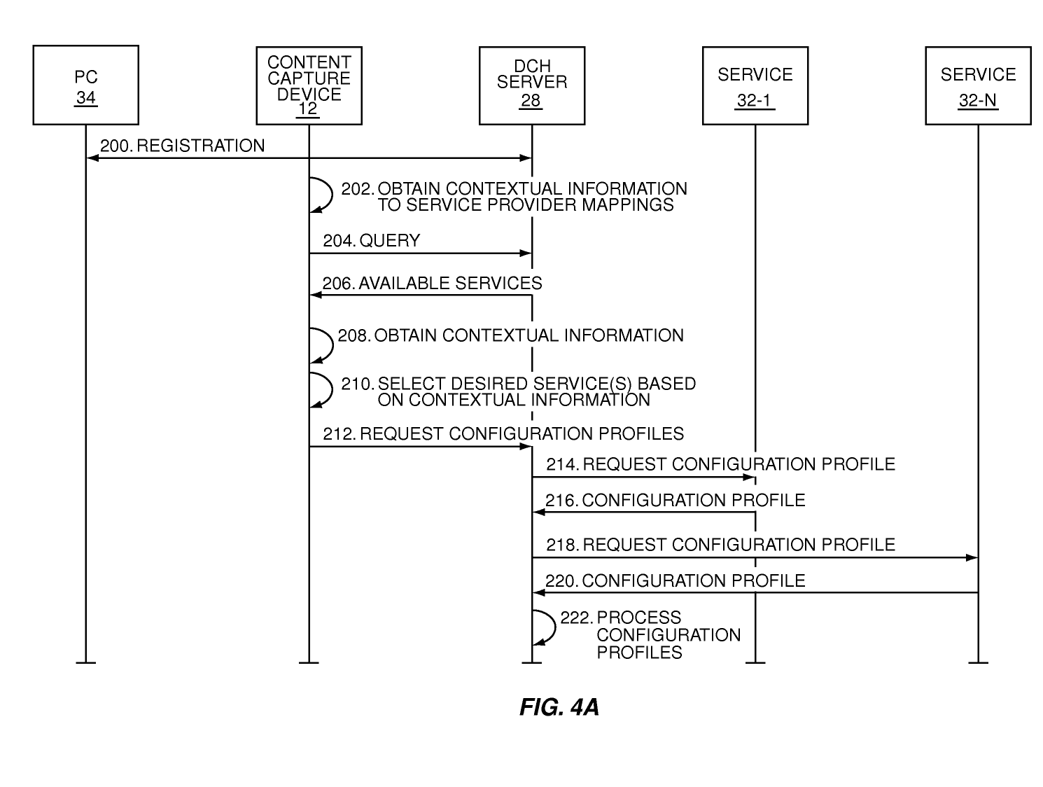

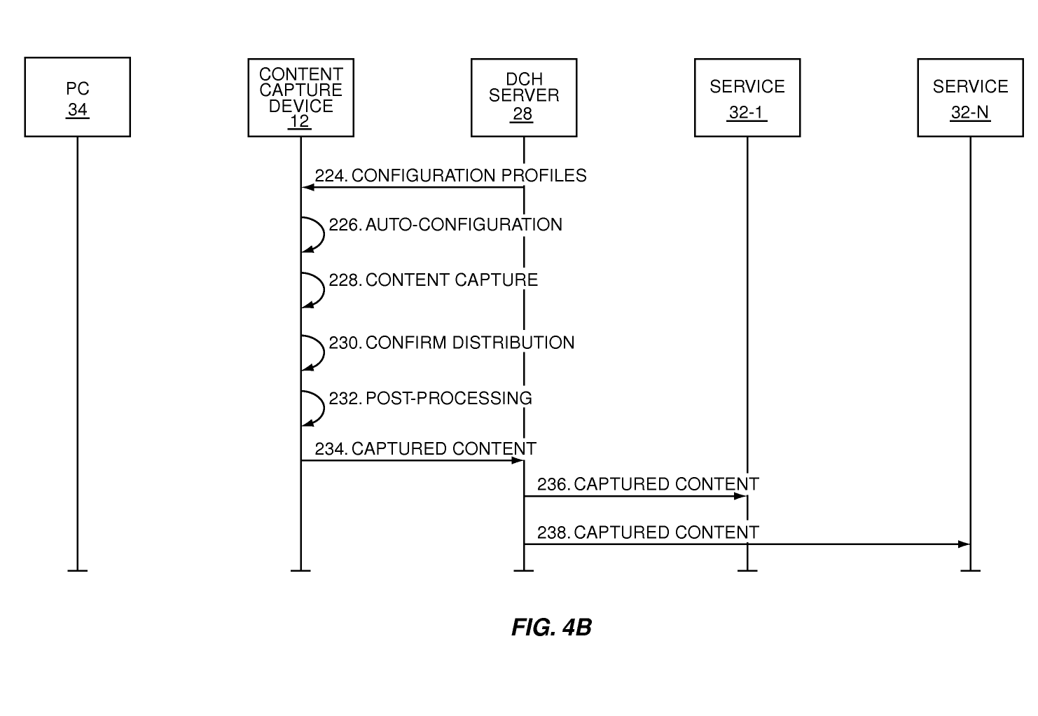

The content capture device 12 then presents at least a portion of the information identifying the services 32-1, 32-N to the user of the content capture device 12, and the user selects a desired one of the services 32-1, 32-N (step 106). In this example, the desired service selected by the user is the service 32-1. While in this example the user selects only one desired service, the present invention is not limited thereto. The user may select multiple desired services such as, for example, a photo sharing web service and a photo printing web service. If multiple services are selected for the same captured content, conflicting configurations for the services may be resolved as discussed below with respect to FIG. 4.

Once the user has selected the desired service 32-1, the content capture device 12 sends a request to the DCH server 28 for a configuration profile for the desired service 32-1 (step 108). As part of the request, or in addition to the request, the content capture device 12 may provide information to the DCH server 28 identifying the capture capabilities of the content capture device 12 or other information, such as the manufacturer, make, and model of the content capture device 12 enabling the DCH server 28 to obtain the capture capabilities of the content capture device 12. In addition, the content capture device 12 may provide user preferences to the DCH server 28. As an example, the content capture device 12 may provide the capture capabilities and user preferences to the DCH server 28 as a Composite Capability/Preference Profile (CC/PP).

The desired service 32-1 may cache the information about the content capture device 12 provided in the request such that the information does not need to be resent in subsequent requests unless the information has changed. Also, the desired service 32-1 may already have default information identifying the capabilities of various types of content capture devices, in which case the content capture device 12 may only need to provide information identifying its device type and optionally any changes to the default information.

In response to the request from the content capture device 12, the DCH server 28 requests the configuration profile from the service 32-1 (step 110). The request provided to the service 32-1 may include information identifying the user of the content capture device 12 or the user's account for the service 32-1. In response, the service 32-1 obtains, or generates, the configuration profile for the user and sends the configuration profile to the DCH server 28 (step 112). The configuration profile may include information such as, but not limited to, capture configurations and user account, or user profile, information. The capture configurations generally define preferred, or optimal, capture configurations for content to be distributed to the service. More specifically, the capture configurations may include, for example, quality configurations such as resolution, encoding parameters, color depth, and the like; size configurations such as a maximum file size; and picture or video capture configurations such as a capture mode, flash mode, aperture setting, shutter speed, white balance, and the like. The user account information may include, for example, an expiration date of the user's account, information identifying the amount of remaining storage space available to the user, and a URL of the service 32-1.

In addition to or as part of the configuration profile, the service 32-1 may provide information identifying sensors or other peripheral attachments that may be connected to the content capture device 12 in which the service 32-1 is interested. As a result, if the content capture device 12 is connected to any of the identified attachments, the content capture device 12 may provide corresponding information from the attachments to the service 32-1 via the DCH server 28 in addition to captured content.

Note that the configuration profile for the service 32-1 may be cached by the DCH server 28. When the configuration profile of the service 32-1 is thereafter needed, the DCH server 28 may first query the service 32-1 to determine if the configuration profile has changed. If so, DCH server 28 may obtain the configuration profile or an update thereto from the service 32-1. If the configuration profile has not changed, the DCH server 28 uses the cached configuration profile for the service 32-1.

Optionally, the DCH server 28 may then process the configuration profile (step 114). Alternatively, the configuration profile may be processed by the service 32-1 prior to sending the configuration profile to the DCH server 28. As an example, if the configuration profile provided by the service 32-1 is not in a format readable by the DCH agent 24, the DCH server 28 may process the configuration profile to convert the configuration profile to a format, such as an Extensible Markup Language (XML) format, readable by the DCH agent 24. As another example, the DCH server 28 may process the configuration profile from the service 32-1 based on the capture capabilities of the content capture device 12. For example, portions of the configuration profile from the service 32-1 relating to capabilities that the content capture device 12 does not have may be removed from the configuration profile prior to sending the configuration profile to the content capture device 12. As yet another example, the DCH server 28 may process the configuration profile based on the user preferences of the content capture device 12. More specifically, the user preferences may identify specific capabilities of the content capture device 12 that are not to be changed or that are not to be changed outside of a desired range. As such, the DCH server 28 may remove configurations for capabilities that are not to be changed from the configuration profile, or may automatically adjust the configurations in the configuration profile for those specific capabilities that are not to be changed outside of desired ranges.

The DCH server 28 then sends the configuration profile to the content capture device 12 (step 116). Note that the configuration profile may optionally be cached at the content capture device 12. When the configuration profile is thereafter needed, the content capture device 12 may query the DCH server 28 to determine whether the configuration profile has changed. If so, the configuration profile or an update thereto is requested. If not, the cached configuration profile is used.

Using the configuration profile, the DCH agent 24 automatically configures the content capture device 12 for the desired service 32-1 (step 118). The DCH agent 24 configures the content capture device 12 based on the capture configurations and, optionally, the user account information. Thus, the DCH agent 24 may consider information such as the amount of storage space available to the user on the service 32-1 in addition to the desired, or optimal, capture configurations for the service 32-1 when configuring the content capture device 12. The user may optionally override the configurations or adjust the configurations as desired. Once the content capture device 12 is configured, content may be captured by the content capture device 12 (step 120). Content may be captured by, for example, taking a picture or by capturing video. Optionally, the content capture device 12 may confirm distribution of the captured content to the service 32-1 with the user (step 122).

Optionally, the content capture device 12, and more specifically the DCH agent 24, may post-process the captured content (step 124). Post-processing may alternatively be performed by the DCH server 28. Post-processing may be desired when the configuration profile for the service 32-1 identifies configurations, such as a desired crop size, that may not be able to be achieved by configuring the content capture system 22; when the user has overridden configurations in the configuration profile such as quality configurations; or when the user preferences of the user of the content capture device 12 have adjusted or removed configurations from the configuration profile. Post-processing may include, for example, cropping the captured content according to a desired crop size of the service 32-1, reducing the quality of the captured content, reducing the size of the captured content, converting the content to a desired file format, compressing the file according to a desired compression algorithm, or the like. For example, if the configuration profile indicates that the quality of the capture content is to be low quality, the user may desire to override this setting to capture high quality content. In response to the override, the DCH agent 24 may post-process the captured content to generate a low quality version of the captured content to be provided to the service 32-1 via the DCH server 28, as discussed below. As another example, if the service 32-1 prefers images having a specified crop size, the DCH agent 24 may crop captured images according to the specified crop size.

At this point, the content capture device 12 provides the captured content, or optionally the post-processed captured content, to the DCH server 28 for distribution to the service 32-1 (step 126). Note that the captured content may be provided to the DCH server 28 as the content is captured or in a batch process. For example, for images, the images may be provided to the DCH server 28 one-by-one as the images are captured or in a batch process. Upon receipt, the DCH server 28 provides the captured content to the service 32-1 (step 128).

In some situations, the service 32-1 may desire additional service specific input from the user of the content capture device 12. For example, the service 32-1 may be a photo sharing web service where the user has created a number of photo albums. Thus, the service 32-1 may desire to know the photo album in which the captured content is to be stored. Note that rather than using user input to select the photo album, the content capture device 12 may select the album based on, for example, context. In order to obtain such additional user input, one of two approaches may be taken. In a first approach, the service 32-1 generates and provides a data entry form, such as an XML data entry form, to the content capture device 12 either directly or via the DCH server 28. The data entry form is processed by the DCH agent 24 and presented to the user via a user interface of the content capture device 12. Once the user has entered the desired information, the information is returned to the service 32-1 either directly or via the DCH server 28. This information may be cached by the content capture device 12 and may be used to automatically respond to subsequent requests from the service 32-1 or to automatically fill in at least a portion of the XML data entry form.

In a second approach, a service specific agent may be implemented on the content capture device 12, where the service specific agent provides the additional functionality desired to obtain information for the service 32-1. In one embodiment, the service specific agent would register itself with the DCH agent 24 and communicate via specified Application Programming Interfaces (APIs) to obtain the desired information from the user. Once obtained, the information is provided to the service 32-1 either directly or via the DCH server 28. Again, this information may be cached by the content capture device 12 and thereafter used by the service specific agent.

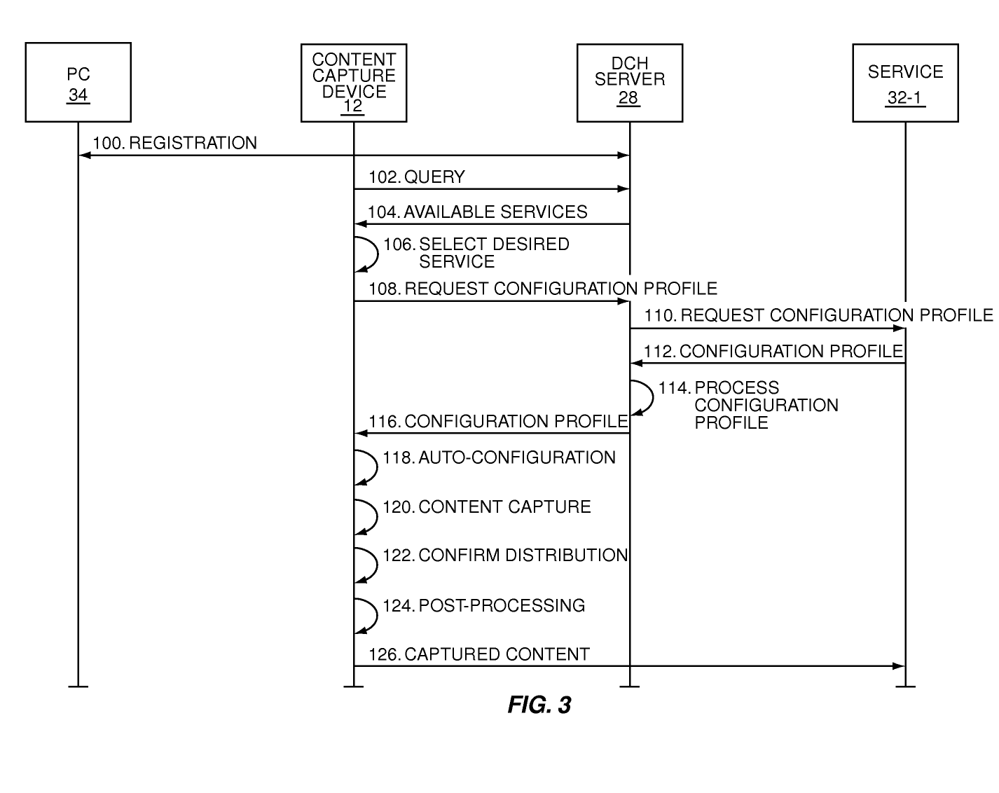

FIG. 3 is substantially the same as FIG. 2. However, in this example, the configuration profile provided to the content capture device in step 116 includes a URL of the service 32-1, and the content capture device 12 sends the captured content directly to the service 32-1 in step 126 rather than sending the captured content to the service 32-1 via the DCH server 28.

FIGS. 4A and 4B illustrate the operation of the system 10 of FIG. 1 according to another embodiment of the present invention. In the embodiments discussed above, the user manually selects one or more desired services. However, in this embodiment, the content capture device 12, and more specifically the DCH agent 24, selects or recommends services based on contextual information.

The process begins when the user registers with the DCH server 28 and the services 32-1, 32-N (step 200). Next, the content capture device 12 obtains contextual information to service provider mappings (step 202). In general, the contextual information to service provider mappings are rules enabling the content capture device 12, and more specifically the DCH agent 24, to map contextual information obtained by the content capture device 12 to one or more of the services 32-1, 32-N in order to automatically select or recommend services, as discussed below. In this embodiment, the contextual information to service provider mappings are entered by the user via a user interface of the content capture device 12. In addition or alternatively, the mappings may be entered by the user at the PC 34 and then provided to the content capture device 12 during a synchronization process or via the DCH server 28. Further, the mappings, which may be default mappings, may additionally or alternatively be provided by the services 32-1, 32-N. Still further, the mappings may additionally or alternatively be obtained for one or more other content capture devices. For example, mappings may be obtained either directly or indirectly from other devices, and the most popular mappings may be selected for use by the content capture device 12.

At some point thereafter, the DCH agent 24 of the content capture device 12 queries the DCH server 28 for available services (step 204). In response, the DCH server 28 provides information identifying the services 32-1, 32-N with which the user has registered (step 206). The information identifying the services 32-1, 32-N may include, for example, names of the services 32-1, 32-N, Uniform Resource Locators (URLs) for the services 32-1, 32-N, information describing the services 32-1, 32-N, or the like.

Prior to capturing content, the content capture device 12 obtains contextual information (step 208). The contextual information may include, for example, the location of the content capture device 12 obtained by a Global Positioning System (GPS) receiver or the like associated with or within the content capture device 12; a current date; a current time of day; one or more keywords to be used to tag subsequently captured content; information describing or identifying people or objects near the content capture device 12 obtained using a Radio Frequency Identification (RFID) reader, Bluetooth interface, IEEE 802.11 interface, or the like associated with or included within the content capture device 12; information obtained from an audio analysis and recognition of sounds in the environment in which the content capture device 12 is located or voices of persons near the content capture device 12; information obtained from image or video analysis and recognition; trust or an indication of trust of users of other mobile devices determined based on, for example, frequent interaction between the content capture device 12 and the other mobile devices via, for example, local wireless communication; or the like. Regarding trust, the interested reader is directed to U.S. patent application Ser. No. 11/290,897, entitled METHODS, SYSTEMS, AND PRODUCTS FOR MEASURING TRUST SCORES OF DEVICES, which was filed Nov. 30, 2005 and is hereby incorporated herein by reference in its entirety.

Once the contextual information is obtained, the DCH agent 24 of the content capture device 12 selects one or more desired services based on the contextual information and the contextual information to service provider mappings (step 210). In one embodiment, the DCH agent 24 may select the one or more desired services 32-1, 32-N automatically. In another embodiment, the DCH agent 24 recommends services 32-1, 32-N to the user by, for example, scoring each of the services 32-1, 32-N, where the user then selects one or more desired services 32-1, 32-N based on the scores.

As a first example, a contextual information to service provider mapping may provide that if the contextual information indicates that the objects near the content capture device 12 or to be captured by the content capture device 12 are to be the user's children, the desired service 32-1 is the user's home content server, which may be hosted on, for example, the user's PC 34. Thus, the DCH agent 24 may evaluate the contextual information such as, for example, keywords or information obtained using audio, image, or video recognition to determine whether the user's children are to be or are likely to be the objects of subsequently captured content. If so, the DCH agent 24 may automatically select or recommend the user's home content server as the desired service 32-1.

As a second example, a contextual information to service provider mapping may provide that if the content capture device 12 is near close friends, at night, in the user's college town, the desired service 32-1 is a content sharing web service such as MySpace. Thus, the DCH agent 24 may evaluate the contextual information such as, for example, keywords, information obtained using audio, image, or video recognition, or trust to determine whether the content capture device 12 is near the user's close friends. The DCH agent 24 may evaluate time of day information from the content capture device 12 to determine whether the current time of day is within a defined time range corresponding to the night. The DCH agent 24 may evaluate contextual information identifying the location of the content capture device 12 such as, for example, information obtained from an associated GPS receiver to determine whether the content capture device 12 is within a range of locations corresponding to the user's college town. Based on the above evaluations, the DCH agent 24 determines whether to automatically select or recommend the associated content sharing web service as the desired service 32-1.

As a third example, a contextual information to service provider mapping may provide that if the content capture device 12 is near close friends, during the day, on the user's college campus, the desired service 32-1 is a content sharing service such as Flickr, where the user's parents may have access to the Flickr service. Thus, the DCH agent 24 may evaluate the contextual information such as, for example, keywords, information obtained using audio, image, or video recognition, or trust to determine whether the content capture device 12 is near the user's close friends. The DCH agent 24 may evaluate time of day information from the content capture device 12 to determine whether the current time of day is within a defined time range corresponding to the day. The DCH agent 24 may evaluate contextual information identifying the location of the content capture device 12 such as, for example, information obtained from an associated GPS receiver to determine whether the content capture device 12 is within a range of locations corresponding to the user's college campus. Based on the above evaluations, the DCH agent 24 determines whether to automatically select or recommend the associated content sharing web service as the desired service 32-1.

As a fourth example, a contextual information to service provider mapping may provide that if the content capture device 12 is at a defined location, or within a defined range of locations, corresponding to the user's Grandma's house and the current date is within the holiday season, the desired service 32-1 is a content sharing web service accessible to the user's family. Thus, the DCH agent 24 may evaluate the contextual information to determine whether these conditions are met. If so, the content sharing web service is selected or recommended as the desired service 32-1.

As a fifth example, a contextual information to service provider mapping may provide that if an image or video is captured of a barcode at close range, the desired service 32-1 is a product pricing service. The DCH agent 24 may evaluate the contextual information to determine whether these conditions are met. If so, the product pricing service is automatically selected or recommended as the desired service 32-1.

When evaluating the contextual information with respect to the contextual information to service provider mappings, the DCH agent 24 may using a scoring algorithm to assist in the selection or recommendation of the desired services 32-1, 32-N. In one embodiment, each condition, or parameter, of a mapping is scored based on the contextual information. For example, each condition may be given a score between 0 and 100. Some conditions may be assigned either 0 or 100 depending on whether the condition is met. Other conditions such as image, video, or audio recognition may be assigned a score between 0 and 100 based on an associated confidence factor. Other conditions such as location, date, and time conditions may be assigned 100 if the condition is met and assigned some score less than 100 if the condition is not met. Thus, for example, if a condition is a range of dates and the contextual information indicates that the current date is only a few days outside of that range of dates, the condition may be assigned a score near 100 such as, for example, 75. The assigned score would continue to decrease as the date is further from the defined range of dates until it eventually reaches 0. The rate at which the score decreases as the date is further from the defined range of dates may be defined, or selected, by the user.

Once each of the conditions for the mapping is scored, the scores are combined to provide a combined score for the mapping. In one embodiment, the scores are averaged to provide the combined score for the mapping. The scores for the conditions may optionally be weighted such that some conditions are given greater weight than other conditions. Thereafter, the combined score may be compared to a defined threshold, where the services 32-1, 32-N whose corresponding mappings are scored above the threshold are automatically selected or recommended as the desired services 32-1, 32-N. The threshold may be defined by the user of the content capture device 12.

In this example, the desired services are the services 32-1 and 32-N. Thus, multiple services are selected. Once the desired services 32-1 and 32-N are selected, the content capture device 12 sends a request to the DCH server 28 for configuration profiles for the desired services 32-1 and 32-N (step 212). As part of the request, or in addition to the request, the content capture device 12 may provide information to the DCH server 28 identifying the capture capabilities of the content capture device 12, or other information, such as the manufacturer, make, and model of the content capture device 12 enabling the DCH server 28 to obtain the capture capabilities of the content capture device 12. In addition, the content capture device 12 may provide user preferences to the DCH server 28. As an example, the content capture device 12 may provide the capture capabilities and user preferences to the DCH server 28 as a Composite Capability/Preference Profile (CC/PP).

In response to the request from the content capture device 12, the DCH server 28 requests the configuration profile from the service 32-1 (step 214). The request provided to the service 32-1 may include information identifying the user of the content capture device 12 or the user's account for the service 32-1. In response, the service 32-1 obtains the configuration profile for the user and sends the configuration profile to the DCH server 28 (step 216). The DCH server 28 also requests the configuration profile from the service 32-N (step 218). Note that the requests to the services 32-1, 32-N may be performed by separate threads. As a result, the requests may be performed concurrently. The request provided to the service 32-N may include information identifying the user of the content capture device 12 or the user's account for the service 32-N. In response, the service 32-N obtains the configuration profile for the user and sends the configuration profile to the DCH server 28 (step 220). In addition to or as part of the configuration profiles, the services 32-1 and 32-N may provide information identifying sensors or other peripheral attachments in which the services 32-1 and 32-N are interested. If the content capture device 12 includes any of the identified attachments, corresponding information is provided to the services 32-1 and 32-N in addition to captured content.

Optionally, the DCH server 28 may then process the configuration profiles (step 222). As an example, if the configuration profiles provided by the services 32-1 and 32-N are not in a format readable by the DCH agent 24, the DCH server 28 may process the configuration profiles to convert the configuration profiles to a format, such as an Extensible Markup Language (XML) format, readable by the DCH agent 24. As another example, the DCH server 28 may process the configuration profiles from the services 32-1 and 32-N based on the capture capabilities of the content capture device 12. For example, portions of the configuration profiles from the services 32-1 and 32-N relating to capabilities that the content capture device 12 does not have may be removed from the configuration profiles prior to sending the configuration profiles to the content capture device 12. As yet another example, the DCH server 28 may process the configuration profiles based on the user preferences of the content capture device 12. More specifically, the user preferences may identify specific capabilities of the content capture device 12 that are not to be changed or that are not to be changed outside of a desired range. As such, the DCH server 28 may remove configurations for capabilities that are not to be changed from the configuration profiles, or may automatically adjust the configurations in the configuration profiles for those specific capabilities that are not to be changed outside of desired ranges.

As illustrated in FIG. 4B, the DCH server 28 then sends the configuration profiles to the content capture device 12 (step 224). Using the configuration profiles, the DCH agent 24 automatically configures the content capture device 12 for the desired services 32-1 and 32-N (step 226). However, since there are two desired services 32-1 and 32-N, the configuration profiles for the two desired services 32-1 and 32-N may include one or more conflicting parameters. For example, the service 32-1 may desire high resolution content while the service 32-N may desire low resolution content. This type of conflict is referred to herein as a non-exclusive conflict because the conflict may be resolved by capturing the content at high resolution for the service 32-1 and using post-processing to generate a low resolution version for the service 32-N. Other types of non-exclusive conflicts may be, for example, size conflicts, orientation conflicts, conflicts in compression parameters or compression algorithms, conflicts in additional attachments from which information is desired where the operation of the additional attachments is non-exclusive, conflicts in keywords to be used to tag the captured content, conflicts in black and white or grayscale settings, conflicts in video encoding rates, and the like.

As another example, the service 32-1 may desire “auto-flash” such that the content capture device 12 uses its flash as needed, and the service 32-N may desire no flash. Since this type of conflict cannot be resolved by post-processing, it is referred to herein as an exclusive conflict. Types of exclusive conflicts include, for example, conflicts in aperture settings, conflicts in shutter speed settings, conflicts in flash mode settings, conflicts in burst mode settings, conflicts in additional attachments from which information is desired where the operation of the additional attachments is exclusive, and the like.

To the extent that conflicts in the configuration profiles from the services 32-1 and 32-N are non-exclusive, the DCH agent 24 may merge the configuration profiles. For each pair of conflicting parameters, the most lossless parameter takes precedence when configuring the content capture device 12. For example, if the configuration profile of the service 32-1 requires a first compression scheme and the configuration profile of the service 32-N requires a second compression scheme that is more lossy than the first compression scheme, the content capture device 12 may be configured to compress captured content according to the first compression scheme. Thereafter, the captured content may be post-processed to generate a second version of the captured content compressed according to the second compression scheme prior to distributing the captured content to the service 32-N.

However, if there are exclusive conflicts in the configuration profiles for the services 32-1 and 32-N and the content capture device 12 is an image capture device, the DCH agent 24 may control or configure the content capture device 12 to utilize a burst mode of the content capture device 12 to take the same photo, in rapid succession, with each of the conflicting parameters. As an example, the configuration profile for the service 32-1 may require auto-flash mode, and the configuration profile for the service 32-N may require no flash. As such, the DCH agent 24 may configure the content capture device 12 to operate in burst mode where an image is first captured in the auto-flash mode and then captured with no flash. Alternatively, if the content capture device 12 has a video mode, the content capture device 12 may be configured to be in video mode where the configurations of the content capture device 12 may subsequently be changed while capturing video of the desired content. The video may then be post-processed to generate desired images from the frames of the video.

Once the content capture device 12 is configured, content may be captured by the content capture device 12 (step 228). Content may be captured by, for example, taking a picture or by capturing video. If the configuration profiles of the services 32-1 and 32-N are non-conflicting or if all conflicting parameters are non-exclusive, the configuration profiles may be merged, as discussed above, and the content capture device 12 captures content while configured based on the merged configuration profiles. However, if there are exclusive conflicting parameters between the configuration profiles for the services 32-1 and 32-N, and the content capture device 12 is an image capture device, the content capture device 12 may be configured to be in burst mode, and the sequence of events for capturing the content may be, for example: (1) the user presses the shutter button of the content capture device 12; (2) the DCH agent 24 configures the content capture device 12 to be in auto-flash mode; (3) the content capture device 12 captures the image; (4) the DCH agent 24 configures the content capture device 12 to use no flash; and (5) the content capture device 12 captures the image with no flash. Alternatively, as discussed above, the content capture device 12 may be placed in video mode, where the configurations are changed while capturing video and desired images are generated from the frames of the video.

If the configuration profiles contain both non-exclusive and exclusive conflicting parameters, the configuration profiles may be merged with respect to the non-exclusive parameters. As for the exclusive conflicting parameters, the content capture device 12 may be configured to operate in burst mode or video mode, as discussed above. Thus, by using the merged configuration profiles and either burst or video mode, the desired content is captured. After capture, the content capture device 12 may optionally confirm distribution of the captured content to the service 32-1 with the user (step 230).

The content capture device 12, and more specifically the DCH agent 24, may post-process the captured content (step 232). Post-processing may alternatively be performed by the DCH server 28. Post-processing may be desired when there are non-exclusive conflicting parameters in the configuration profiles for the services 32-1 and 32-N; when the configuration profiles for the services 32-1 and 32-N identify configurations, such as a desired crop size, that may not be able to be achieved by configuring the content capture system 22; when the user has overridden configurations in the configuration profiles such as quality configurations; or when the user preferences of the user of the content capture device 12 have adjusted or removed configurations from the configuration profiles.

At this point, the content capture device 12 provides the captured content, or optionally the post-processed captured content, to the DCH server 28 for distribution to the services 32-1 and 32-N (step 234). Note that the captured content may be provided to the DCH server 28 as the content is captured or in a batch process. For example, for images, the images may be provided to the DCH server 28 one-by-one as the images are captured or multiple images may be provided to the DCH server 28 in a batch process. Upon receipt, the DCH server 28 provides the captured content to the services 32-1 and 32-N (steps 236 and 238). Note that, based on the configuration profiles, different versions of the captured content may be provided to the services 32-1 and 32-N.

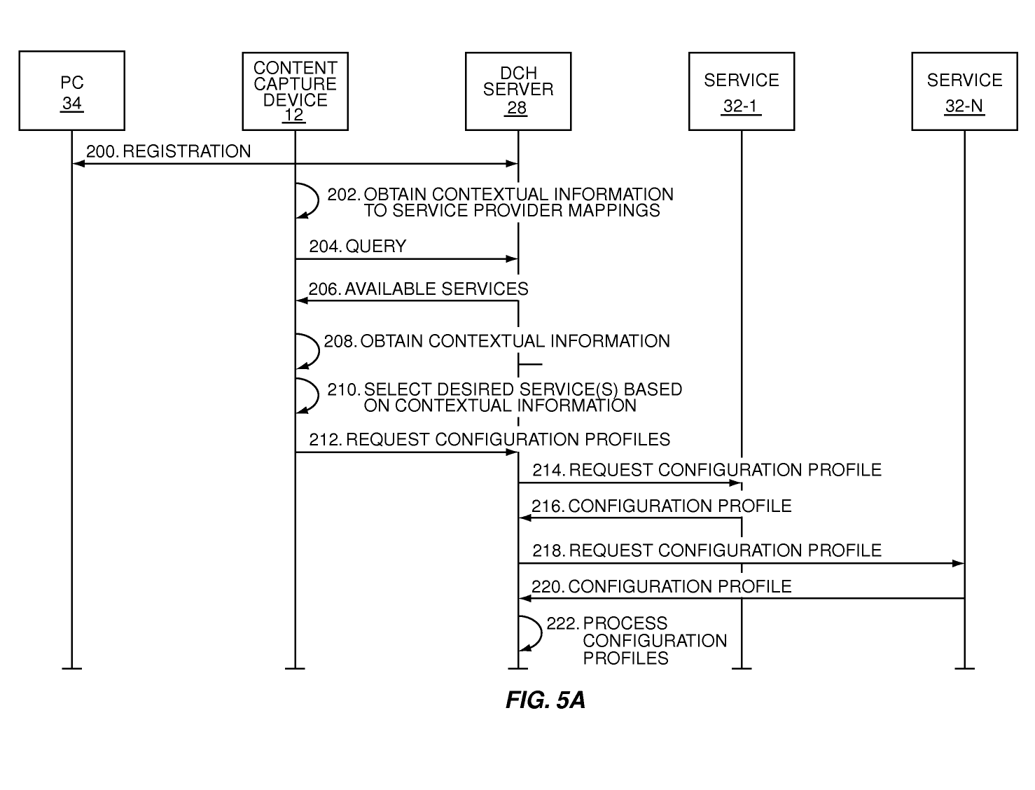

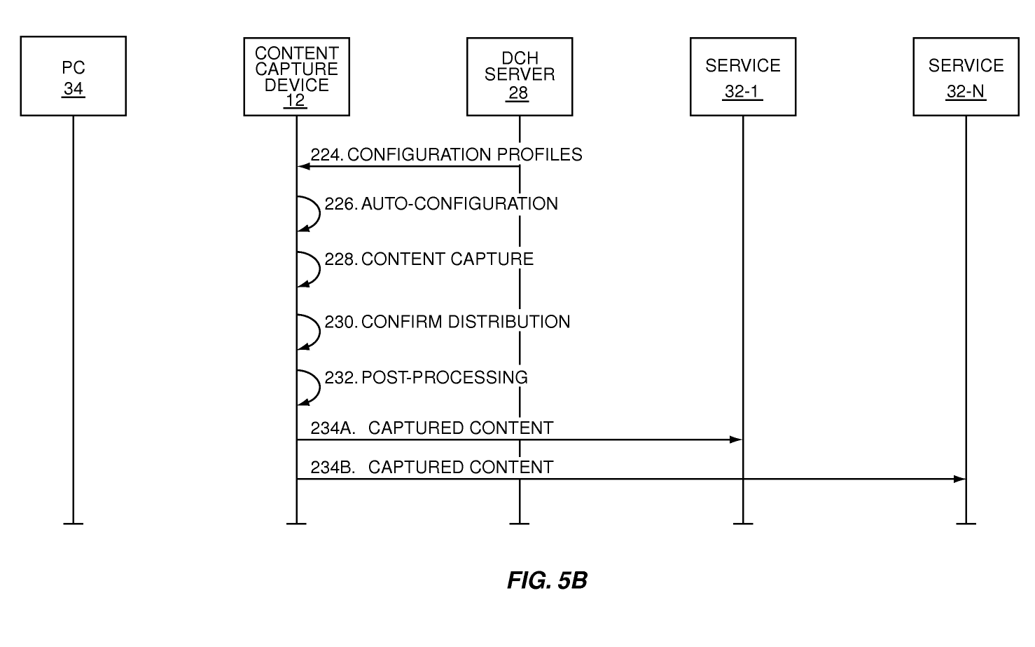

FIGS. 5A and 5B are substantially the same as FIGS. 4A and 4B. However, in this example, the configuration profiles provided to the content capture device 12 in step 224 includes URLs of the services 32-1 and 32-N, and the content capture device 12 sends the captured content directly to the services 32-1 and 32-N in steps 234A and 234B rather than sending the captured content to the services 32-1 and 32-N via the DCH server 28.

Regarding FIGS. 4A, 4B, 5A, and 5B, while automatically selecting or recommending services at the content capture device 12 based on contextual information is described above with respect to the DCH system 14, the present invention is not limited thereto. Alternatively, the content capture device 12 may interact directly with the services 32-1, 32-N to obtain configuration profiles and to distribute captured content to desired ones of the services 32-1, 32-N based on contextual information obtained by the content capture device 12.

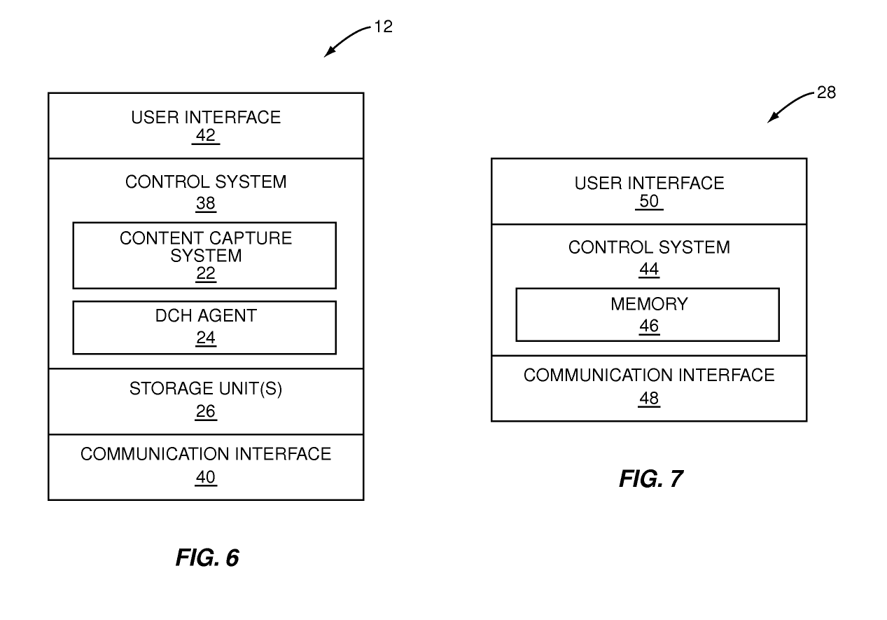

FIG. 6 is a block diagram of an exemplary embodiment of the content capture device 12. In general, the content capture device 12 includes a control system 38, wherein the control system 38 includes the content capture system 22 and the DCH agent 24. The control system 38 includes various components enabling content capture, as will be apparent to one of ordinary skill in the art upon reading this disclosure. The DCH agent 24 may be implemented in software, hardware, or a combination thereof. As discussed above, the storage unit 26 operates to store content captured by the content capture device 12. The content capture device 12 also includes a communication interface 40 communicatively coupling the content capture device 12 to the network 16 (FIG. 1). The communication interface 40 may be a local wireless interface operating according to, for example, the Bluetooth standard, one of the suite of IEEE 802.11 standards, or the like, or a cellular interface operating according to, for example, the GSM standard, the WCDMA standard, or the like. The content capture device 12 also includes a user interface 42 which may include, for example, a display, input buttons or keys, a microphone, a speaker, and the like.

FIG. 7 is a block diagram of an exemplary embodiment of the DCH server 28. Note that while the DCH server 28 is illustrated as a hardware server, the DCH server 28 may alternatively be implemented entirely in software and hosted by a separate hardware server associated with the DCH system 14 (FIG. 1). In general, the DCH server 28 includes a control system 44 having associated memory 46. The memory 46 operates to store software instructing the DCH server 28 to operate according to the present invention. The DCH server 28 also includes a communication interface 48 communicatively coupling the DCH server 28 to the networks 16 and 20 (FIG. 1). The DCH server 28 also includes a user interface 50, which may include components such as, for example, a display, keyboard, and the like.

The present invention also provides the opportunity for numerous revenue models. As a first example, the services 32-1, 32-N may be enabled to display advertising on the content capture device 12 when being utilized by the content capture device 12. The advertisements may be provided as part of the configuration profiles or provided separately to the content capture device 12 via the DCH sever 28 or directly. As a second example, the DCH server 28 may interact with the DCH agent 24 to prompt the user of the content capture device 12 to register for additional services 32-1, 32-N. The service providers 18-1, 18-N may pay to have their services 32-1, 32-N placed at the top of a list of available new services. Further, each time the user of the content capture device 12 registers for a new service in response to such a prompt, the associated service provider 18-1, 18-N may be charged a fee.

The present invention provides substantial opportunity for variation without departing from the spirit or scope of the present invention. For example, while the discussion above focuses on obtaining the configuration profiles of the desired services 32-1, 32-N as needed, the configuration profiles of all of the services 32-1, 32-N may alternatively be pushed to the content capture device 12 by the services 32-1, 32-N or otherwise provided to the content capture device 12 prior to selection of a desired service. As a result, once a desired service is selected, the corresponding configuration profile may already be stored locally at the content capture device 12.

Those skilled in the art will recognize improvements and modifications to the preferred embodiments of the present invention. All such improvements and modifications are considered within the scope of the concepts disclosed herein and the claims that follow.

What is claimed is:

1. A method comprising:
selecting a desired service from a plurality of services available to a digital content capture device, wherein content captured by the digital content capture device is to be distributed to the desired service; and
configuring the digital content capture device based on a configuration profile for the desired service.

2. The method of claim 1 further comprising identifying the plurality of services available to the digital content capture device prior to selecting the desired service.

3. The method of claim 2 wherein identifying the plurality of services comprises sending a query to a configuration server via a network and receiving a response including information identifying the plurality of services from the configuration server.

4. The method of claim 1 wherein selecting the desired service comprises enabling a user of the digital content capture device to select the desired service from the plurality of services via a user interface of the digital content capture device.

5. The method of claim 1 wherein selecting the desired service comprises:
obtaining contextual information at the digital content capture device; and
selecting the desired service from the plurality of services based on the contextual information.

6. The method of claim 5 wherein selecting the desired service from the plurality of services based on the contextual information comprises:
comparing the contextual information to a plurality of rules defining contextual information to service provider mappings for the plurality of services; and
selecting the desired service from the plurality of services based on the comparison of the contextual information to the plurality of rules.

7. The method of claim 6 further comprising obtaining the plurality of rules defining the contextual information to service provider mappings from a user of the digital content capture device.

8. The method of claim 6 further comprising obtaining the plurality of rules defining the contextual information to service provider mappings from the plurality of services.

9. The method of claim 6 further comprising obtaining the plurality of rules defining the contextual information to service provider mappings from at least one other digital content capture device.

10. The method of claim 6 wherein comparing the contextual information to the plurality of rules comprises, for each rule of the plurality of rules:
comparing each condition of the rule to the contextual information; and
generating a score for the rule based on the comparisons of each condition of the rule to the contextual information;
wherein selecting the desired service from the plurality of services comprises selecting the desired service from the plurality of services based on the scores of the plurality of rules.

11. The method of claim 6 wherein selecting the desired service from the plurality of services based on the comparison of the contextual information to the plurality of rules comprises:
recommending at least one of the plurality of services to a user of the digital content capture device based on the comparison of the contextual information to the plurality of rules; and
enabling the user to select the desired service from the at least one of the plurality of services.

12. The method of claim 6 wherein selecting the desired service from the plurality of services based on the comparison of the contextual information to the plurality of rules comprises automatically selecting the desired service from the plurality of services based on the comparison of the contextual information to the plurality of rules.

13. The method of claim 5 wherein obtaining the contextual information comprises obtaining at least one of a group consisting of: a location of the digital content capture device, a current date, a current time of day, one or more keywords to be used to tag subsequently captured content, information identifying people near the digital content capture device, information identifying objects near the digital content capture device, information obtained via audio analysis and recognition of sounds near the digital content capture device, information obtained via audio analysis and recognition of voices of persons near the digital content capture device, information obtained via image analysis and recognition of persons near the digital content capture device, information obtained via image analysis and recognition of objects near the digital content capture device, information obtained via video analysis and recognition of persons near the digital content capture device, information obtained via video analysis and recognition of objects near the digital content capture device, and trust.

14. The method of claim 1 further comprising obtaining the configuration profile for the desired service.

15. The method of claim 14 wherein obtaining the configuration profile for the desired service comprises:
sending a request for the configuration profile to an associated configuration server via a network; and
receiving the configuration profile from the configuration server;
wherein the configuration server is an intermediary between the digital content capture device and the plurality of services, and the configuration server obtains the configuration profile from the desired service.

16. The method of claim 1 wherein configuring the digital content capture device comprises automatically configuring the digital content capture device based on the configuration profile.

17. The method of claim 1 further comprising:
capturing content at the digital content capture device; and
providing the captured content to the desired service.

18. The method of claim 17 wherein providing the captured content to the desired service comprises providing the captured content to a configuration server, wherein the configuration server is an intermediary between the digital content capture device and the plurality of services, and the configuration server provides the captured content to the desired service.

19. The method of claim 17 wherein providing the captured content to the desired service comprises providing the captured content directly to the desired service via a network.

20. The method of claim 1 further comprising:
capturing content at the digital content capture device;
processing the captured content based on the configuration profile to provide modified content; and
providing the modified content to the desired service.

21. The method of claim 20 wherein processing the captured content based on the configuration profile comprises processing the captured content at the digital content capture device.

22. The method of claim 20 further comprising:
providing the captured content to a configuration server operating as an intermediary between the digital content capture device and the plurality of services;
wherein processing the captured content based on the configuration profile comprises processing the captured content at the configuration server, and providing the modified content to the desired service comprises providing the modified content from the configuration server to the desired service.

23. The method of claim 1 further comprising:
selecting a plurality of desired services including the desired service from the plurality of services;
obtaining configuration profiles including the configuration profile for the plurality of desired services; and
configuring the digital content capture device based on the configuration profiles for the plurality of desired services.

24. The method of claim 23 wherein the configuration profiles comprise non-exclusive configuration parameters and configuring the digital content capture device comprises merging the configuration profiles with respect to the non-exclusive configuration parameters to provide a merged configuration profile and configuring the digital content capture device based on the merged configuration profile.

25. The method of claim 24 further comprising:
capturing content at the digital content capture device;
processing the captured content based on the configuration profiles to provide a version of the captured content for each of the plurality of desired services; and
distributing the versions of the captured content to the plurality of desired services.

26. The method of claim 23 wherein the digital content capture device is an image capture device and the configuration profiles comprise exclusive configuration parameters, further wherein configuring the digital content capture device comprises configuring the image capture device to be in a burst mode, the method further comprising:
capturing content at the digital content capture device in a plurality of bursts; and
varying the configurations of the digital content capture device for each of the plurality of bursts based on the configuration profiles to obtain a version of the captured content for each of the plurality of desired services.

27. The method of claim 23 wherein the digital content capture device is an image capture device having a video mode and the configuration profiles comprise exclusive configuration parameters, further wherein configuring the digital content capture device comprises configuring the image capture device to be in the video mode, the method further comprising:
capturing video content at the digital content capture device;
varying the configurations of the digital content capture device while capturing the video content based on the configuration profiles; and
generating images for the plurality of desired services from frames of the video content.

28. The method of clam 1 wherein the configuration profile includes capture configurations and user account information, the user account information providing information related to an account of a user of the digital content capture device with the desired service.

29. A digital content capture device comprising:
a communication interface communicatively coupling the digital content capture device to a network; and
a control system associated with the communication interface and adapted to:
select a desired service from a plurality of services available to the digital content capture device, wherein content captured by the digital content capture device is to be distributed to the desired service via the network; and
configure the digital content capture device based on a configuration profile for the desired service.

30. The digital content capture device of claim 29 wherein the control system is further adapted to identify the plurality of services available to the digital content capture device.

31. The digital content capture device of claim 30 wherein, in order to identify the plurality of services, the control system is further adapted to query a configuration server and receive a response from the configuration server including information identifying the plurality of services, the configuration server operating as an intermediary between the digital content capture device and the plurality of services.

32. The digital content capture device of claim 29 wherein, in order to select the desired service, the control system is further adapted to enable a user of the digital content capture device to select the desired service from the plurality of services via a user interface of the digital content capture device.

33. The digital content capture device of claim 29 wherein the control system is further adapted to:
obtain contextual information at the digital content capture device; and
select the desired service from the plurality of services based on the contextual information.

34. The digital content capture device of claim 33 wherein in order to select the desired service, the control system is further adapted to:
recommend at least one of the plurality of services to a user of the digital content capture device based on the contextual information; and
enable the user to select the desired service from the at least one of the plurality of services.

35. The digital content capture device of claim 33 wherein the control system is further adapted to automatically select the desired service from the plurality of services based on the contextual information.

36. The digital content capture device of claim 29 wherein the control system is further adapted to:
capture content at the digital content capture device; and
provide the captured content to the desired service.

37. The digital content capture device of claim 36 wherein the control system is further adapted to provide the captured content to a configuration server, wherein the configuration server operates as an intermediary between the digital content capture device and the plurality of services and provides the captured content to the desired service.

38. The digital content capture device of claim 36 wherein the control system is further adapted to provide the captured content directly to the desired service via the network.

39. The digital content capture device of claim 29 wherein the control system is further adapted to obtain the configuration profile for the desired service.

40. The digital content capture device of claim 39 wherein the control system is further adapted to obtain the configuration profile for the desired service from a configuration server via the network, the configuration server operating as an intermediary between the digital content capture device and the plurality of services and obtaining the configuration profile from the desired service.

41. A system operating as an intermediary between a digital content capture device and a plurality of services comprising:
a communication interface communicatively coupling the system to the digital content capture device and the plurality of services via at least one network; and
a control system adapted to:
receive a request from the digital content capture device for a configuration profile of a desired service from the plurality of services;
obtain the configuration profile from the desired service; and
provide the configuration profile to the digital content capture device, wherein the digital content capture device is configured based on the configuration profile.

42. The system of claim 41 wherein the control system is further adapted to modify the configuration profile based on user preferences of a user of the digital content capture device and provide the modified configuration profile to the digital content capture device.

43. The system of claim 41 wherein the control system is further adapted to receive captured content from the digital content capture device and provide the captured content to the desired service.

44. The system of claim 41 wherein the control system is further adapted to:
receive captured content from the digital content capture device;
process the captured content based on the configuration profile to provide modified content; and
provide the modified content to the desired service.
